(19) United States
(12) Patent Application Publication
(10) Pub. No.: US 2020/0070176 A1
(43) Pub. Date: Mar. 5, 2020

(54) Cutting Unit For Recovering Gluten From A Mixture Containing Starch And Gluten

(71) Applicant: NETZSCH PUMPEN & SYSTEME GMBH, Selb (DE)

(72) Inventors: Stefan Weigl, Muehldorf am Inn (DE); Herbert Brunner, Bodenkirchen (DE); Achim Dehnz, Söchtenau (DE); Dominik Hindera, Winhöring (DE); Franz Kneidl, Waldkraiburg (DE); Thomas Schmitt, Lohkirchen (DE); Stefan Schoeberl, Buchbach (DE); Erwin Weber, München (DE); Horst Engl, Roth (DE)

(21) Appl. No.: 16/349,861

(22) PCT Filed: Nov. 14, 2017
(86) PCT No.: PCT/DE2017/000386

§ 371 Date: May 14, 2019

(30) Foreign Application Priority Data
Nov. 16, 2016 (DE) 10 2016 013 689.8

(51) Int. Cl. B02C 18/14; B02C 18/18; A23J 1/12

(52) U.S. Cl. CPC B02C 18/142; A23J 1/12; B02C 18/182; B02C 18/146

(57) ABSTRACT

A cutting unit for recovering gluten from a mixture containing starch and gluten, having a housing in which is formed a cutting chamber having an inlet and an outlet. A first shaft, which is mounted in a rotatable manner in the housing, has a multiplicity of first disc-like cutting tools, which are fitted in a rotationally fixed manner on the first shaft, wherein in each case two adjacent cutting tools of the multiplicity of first cutting tools are spaced apart from one another axially to form an interspace. A second shaft, which is mounted in a rotatable manner in the housing is arranged parallel to the first shaft and has a multiplicity of second disc-like cutting tools, which are fitted in a rotationally fixed manner on the second shaft, wherein in each case two adjacent cutting tools of the multiplicity of second cutting tools are spaced apart from one another axially to form a further interspace. The first and second cutting tools are arranged in the cutting chamber, wherein the first and the second shafts are spaced apart from one another radially, and the multiplicity of first cutting tools are offset axially relative to the multiplicity of second cutting tools, such that at least one portion of one of the multiplicity of second cutting tools engages in an interspace. A respective gap having a width of at least 0.3 mm is formed in the axial direction between the at least one engaging portion and the two adjacent, interspace-forming first cutting tools.

### TECHNICAL FIELD

The present invention relates to a shearing unit, a system comprising a shearing unit, and a pump mechanism connected thereto, as well as a method for recovering gluten from a mixture containing starch and gluten.

### BACKGROUND

The substance mixture gluten is used as diluent in the food industry, because it can increase its volume by up to 150% by absorbing water. Gluten is recovered from mixtures containing starch and gluten, such as, for example, wheat dough. For this purpose, in particular starch and other soluble components have to be washed out of the mixture. A difficulty in response to washing the starch and other soluble components out of the mixture results from the viscous and dough-like consistency of the mixture. In conventional industrial methods for the production of gluten, the mixture is processed in a plurality of stages by means of devices, which comprise agglomerators, centrifuges and/or washing screens, which are coupled to one another. The recovered gluten is subsequently dried and ground for further use.

Due to the level of wash-out of the starch and soluble components, the recovery process influences the protein content of the recovered gluten, which, in turn, is crucial for the later area of application of the gluten. While gluten with a protein content of above 75% can be used in the food industry, gluten with a protein content of less than 75% serves only as animal feed. The protein content of the gluten thus also determines the price thereof. It applies as a general rule that the higher the protein content of the gluten, the higher the quality as well as the cost of the gluten.

To increase the protein content of the gluten as part of its recovery, different auxiliary devices are already integrated into gluten recovery systems. Auxiliary devices known from practice are based on the rotor-stator principle, whereby the gluten is impacted by means of an interaction of a rotor with a stator. However, such devices of the prior art cause high costs and only attain a small increase of the protein content of the gluten.

### SUMMARY

It is thus an object of the present invention to provide a device and a method for recovering gluten, which increase the protein content of the recovered gluten.

According to the invention, this object is solved by means of a shearing unit, system, and method.

Preferred embodiments are subject matter of the dependent claims and become apparent from the following description.

The shearing unit according to the invention for recovering gluten from a mixture containing starch and gluten comprises a housing, in which a shearing chamber comprising an inlet and an outlet is formed, as well as a first shaft, which is rotatably mounted in the housing and which has a plurality of disk-shaped first shearing tools, which are attached to the first shaft in a rotationally fixed manner, wherein two adjacent shearing tools of the plurality of first shearing tools are in each case axially spaced apart from one another, so that they form an interspace. The shearing unit further comprises a second shaft, which is rotatably mounted in the housing and which is arranged parallel to the first shaft and which has a plurality of disk-shaped second shearing tools, which are attached to the second shaft in a rotationally fixed manner, wherein two adjacent shearing tools of the plurality of second shearing tools are in each case axially spaced apart from one another, so that they form a further interspace. The first and second shearing tools are arranged in the shearing chamber, wherein the first and the second shaft are radially spaced apart from one another and the plurality of first shearing tools is offset axially relative to the plurality of second shearing tools in such a way that at least one portion of one of the plurality of second shearing tools engages with an interspace. A gap of a width of at least 0.3 mm, preferably at least 0.5 mm, is in each case formed in the axial direction between the at least one engaging portion and the two adjacent first shearing tools forming the interspace.

In other words, the shearing unit is a two-shaft machine, which is set up to apply shear stresses on the mixture containing starch and gluten, which is to be processed, whereby during operation even mixtures comprising viscous, dough-like consistency and also fibrous mixtures can be processed. More specifically, the shear stresses in response to a rotation of the first and/or second shaft are generated by an interaction of the at least one engaging portion, of the two adjacent first shearing tools forming the interspace, and of the gap formed between them. The gap formed between the at least one engaging portion and the two adjacent first shearing tools forming the interspace, thereby simultaneously prevents a cutting stress of the mixture, which is to be processed.

In a further development of the shearing unit according to the invention, at least one portion of one of the plurality of first shearing tools can further engage with the further interspace. In this further development, a further gap of a width of at least 0.3 mm, preferably at least 0.5 mm, is in each case formed in the axial direction between the at least one engaging portion of one of the plurality of first shearing tools and the two adjacent second shearing tools forming the further interspace. As in the case of the above-described gap, the further gap also prevents a cutting stress of the mixture, which is to be processed, in response to an operation of the shearing unit. The interaction of the at least one engaging portion of one of the plurality of first shearing tools, of the two adjacent second shearing tools forming the further interspace, and of the further gap simultaneously generates shear stresses, which impact the mixture, in response to a rotation of the first and/or second shaft.

The shearing unit according to the invention can have a plurality of interspaces formed by first and second shearing tools, and further interspaces, with which portions, which temporarily differ due to a rotation of the first and/or second shaft, of respective corresponding second or first shearing tools, respectively, engage. The shearing unit according to the invention can accordingly also have a plurality of gaps. Due to the fact that the first and second shearing tools can mutually engage with one another, one gap can simultaneously correspond to a further gap.

In a further embodiment of the shearing unit according to the invention, the gap and/or the further gap can have an axial width of at least 1 mm, preferably of at least 2 mm. The exact axial width of the gap and/or of the further gap can be selected as a function of the structural formation or dimensions of the shearing unit and of its components and/or as a function of the mixture, which is to be processed. The intensity of the shear stress, which can be attained by means of the shearing unit, can be influenced via the selection of the axial gap width, and an unwanted cutting of the mixture can be safely prevented.

In a further development of the invention, the first shearing tools and/or the second shearing tools can be star-shaped. A serration can furthermore be formed on an outer circumferential surface of at least one star point of the first shearing tool and/or of the second shearing tool at least in sections. All outer circumferential surfaces of a plurality of or of all star points of the first shearing tool and/or of the second shearing tool can have a serration. By a formation of serrations on the cutting tools, the shear stresses, which can be applied to the mixture by means of the shearing unit, can be influenced, whereby in particular an increase of the shear stress can be attained thereby.

Alternatively to the above-described embodiment, the first shearing tools and/or the second shearing tools can also have any other, non-star-shaped geometric shape with or without serrations on the outer circumferential surface. The shearing tools can, for example, have a wave-shaped outer circumference with or without serration in sections.

According to a further development of the invention, the plurality of first shearing tools and/or the plurality of second shearing tools can be arranged on a sleeve in a rotationally fixed manner, wherein the sleeve is connected in a rotationally fixed manner to the corresponding first and/or second shaft. This further development provides for a simple assembly and disassembly of the shearing tools on the corresponding shaft, because the shearing tools can thus be exchanged as joint unit with the sleeve. This has an advantageous impact on the maintenance, the cleaning, and a structural adaptability of the shearing unit according to the invention.

In a further embodiment, the plurality of first shearing tools and/or the plurality of second shearing tools of the shearing unit according to the invention can be fastened to the corresponding shaft inside the shearing chamber in a screwless manner. The entire shearing chamber can thus be free from screws, so that no screws or screw heads come into contact with the mixture, which is to be sheared. This is significant, in particular for the use of the recovered gluten in the food production, because it is prevented by means of a screwless shearing chamber, that loosened or destroyed screws and screw parts reach into the gluten and thus into the food. A screw-free shearing chamber also provides for a further simplified cleaning, due to a reduction of small parts, which need to be cleaned.

For a screwless assembly of the plurality of first shearing tools and/or of the plurality of second shearing tools to the corresponding shaft, the shearing tools can in each case be pushed onto the corresponding sleeve. For this purpose, each of the shearing tools can have an inner circumference with a diameter, which is slightly larger than the diameter of an outer circumference of the sleeve.

For a rotationally fixed connection of the shearing tools to the corresponding sleeve, separate pins or springs, for example, can further be provided between the respective shearing tools and the corresponding sleeve. To form a rotationally fixed connection, these pins engage with axial recesses on the inner circumference of the shearing tools in sections and with elongated grooves, which extend in the axial direction, on the outer circumferential surface of the corresponding sleeve. Alternatively, a groove-spring connection can also be formed directly, i.e., without additional pins, on the inner circumferential surface of the shearing tools and the outer circumferential surface of the corresponding sleeve.

In both above-described cases, a shearing tool, which locks the shearing tool arrangement and which defines the shearing chamber in sections and which has at least one surface, which is not arranged in the shearing chamber, can be attached to the sleeve. This surface comprises bores, into which screws are introduced for fixedly locking the locking shearing tool to the sleeve. A screwing of the locking shearing tool with the sleeve secures the plurality of shearing tools, thus the shearing tool arrangement, on the corresponding sleeve and defines or prevents, respectively, an axial play of the shearing tools, which are pushed onto the sleeve. Due to the fact that the screw heads sit on the surface, which is not arranged in the shearing chamber, in this exemplary embodiment, and the screw shafts are screwed completely in the bodies of the locking shearing tool and the sleeve, no portion of the screws extends into the shearing chamber, so that no screw part comes into contact with the mixture, which is to be processed.

In a further development of the invention, the shearing unit can further comprise a drive mechanism, which is connected to the first shaft and the second shaft via a belt drive. The drive mechanism is designed to rotate the first shaft at a first speed and to rotate the second shaft at a second speed by means of the belt drive. The first speed can differ from the second speed. The direction of rotation of the first shaft can also differ from the direction of rotation of the second shaft. By driving the shafts at different speeds and/or directions of rotation, additional shear effects can be generated. By an adaptation of the belt drive, i.e., a defined control of the drive mechanism and/or an adjustment of the belt drive, the shear effect of the shearing unit can be changed even during the operation.

According to a further embodiment of the invention, the shearing unit can comprise a secondary substance inflow, which is set up to supply a medium to the shearing chamber. By supplying a medium, the solubilized starch and the other solubilized components are already washed out of the mixture during the processing. The secondary substance inflow can in particular be a water lance, which is set up to supply water to the shearing chamber, wherein a supply opening of the water lance is preferably arranged in the region of the inlet of the shearing chamber.

The invention furthermore relates to a system comprising a shearing unit of the above-described type and a pump mechanism connected thereto, preferably a hopper pump, which is set up to convey a mixture, which is to be sheared, through the shearing chamber of the shearing unit.

The invention also relates to a method for recovering gluten from a mixture containing starch and gluten, comprising the steps:

supplying a mixture into a shearing chamber of a shearing unit, in particular of a shearing unit of the above-described type,

rotationally driving a first shaft, which has a plurality of disk-shaped first shearing tools, which are attached to the first shaft in a rotationally fixed manner, wherein two adjacent shearing tools of the plurality of first shearing tools are in each case axially spaced apart from one another, so that they form an interspace,

rotationally driving a second shaft, which is arranged parallel to the first shaft and which has a plurality of disk-shaped second shearing tools, which are attached to the second shaft in a rotationally fixed manner, wherein two adjacent shearing tools of the plurality of second shearing tools are in each case axially spaced apart from one another, so that they form a further interspace,

wherein the first and second shearing tools are arranged in the shearing chamber,

repeatedly allowing at least one portion of one of the plurality of second shearing tools to engage with the interspace by rotationally driving the first and the second shaft, wherein a gap of a width of at least 0.3 mm, preferably at least 0.5 mm, is each case formed in the axial direction between the at least one portion and the two adjacent first shearing tools forming the interspace.

In a further development, the method according to the invention can further comprise the steps:

supplying a medium, such as, for example, water, air, salt, etc., or a substance mixture, for example a fluid-solid mixture, into the shearing chamber, preferably directly, and

rinsing the starch, which was dissolved out, out of the mixture by means of the supplied medium.

In a further development, the method according to the invention can further comprise the steps:

pressurizing the shearing chamber; and preferably

varying the pressure inside the shearing chamber during the gluten recovery process, i.e., increasing or reducing the applied pressure for the systematic intensifying or reducing of the effects of the method.

According to a further embodiment, the method according to the invention can be influenced by an adjusting of further process variables. For example, the temperature of the mixture can thus be adapted or controlled by means of heating elements or via the supplied medium. For example, the flow rate of the mixture, thus the volume flow of the mixture, can further be varied.

It goes without saying that the above-described shearing unit and the above-described method cannot only be used to break up and recover gluten, but also to shear further two-phase mixtures.

### BRIEF DESCRIPTION OF THE DRAWINGS

Preferred embodiments of the invention will be described in more detail below by means of the enclosed, schematic drawings, in which

FIG. 1 shows a perspective view of a housing and shearing tools of the shearing unit according to the invention, which are arranged on sleeves;

FIG. 2 shows a section of a sectional illustration of the shearing unit according to the invention in the region of the shearing chamber;

FIG. 3 shows a section of a sectional illustration of the shearing unit according to the invention comprising a belt drive;

FIG. 4 shows an enlarged detail view of a region of the sectional illustration from FIGS. 2 and 3;

FIG. 5 shows a perspective exploded drawing of a first shearing tool arrangement of the shearing unit according to the invention;

FIG. 6 shows a sectional illustration of the first shearing tool arrangement from FIG. 5;

FIG. 7 shows a perspective view of the first shearing tool arrangement from FIG. 5;

FIG. 8 shows a perspective exploded drawing of a second shearing tool arrangement of the shearing unit according to the invention;

FIG. 9 shows a sectional illustration of the second shearing tool arrangement from FIG. 8;

FIG. 10 shows a perspective view of the second shearing tool arrangement from FIG. 8;

FIG. 11 shows a perspective view of a first exemplary embodiment of a shearing tool of the shearing unit according to the invention;

FIG. 12 shows a perspective view of a second exemplary embodiment of a shearing tool of the shearing unit according to the invention;

FIG. 13 shows a perspective view of a third exemplary embodiment of a shearing tool of the shearing unit according to the invention.

### DETAILED DESCRIPTION

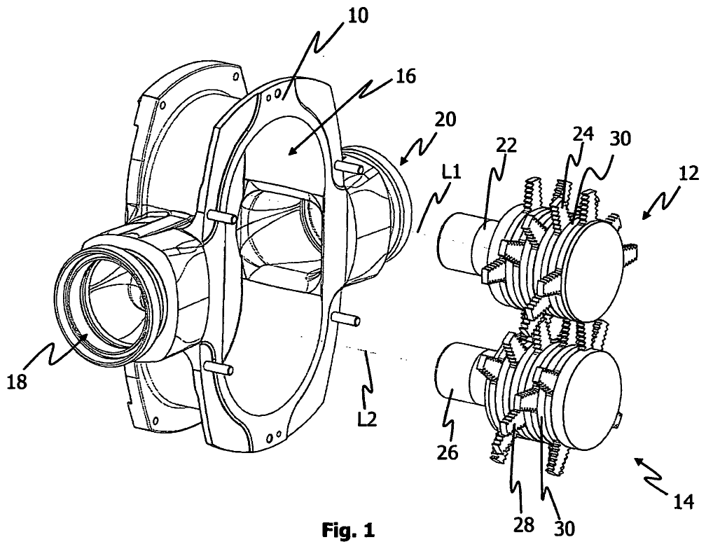

FIG. 1 shows a housing 10 as well as a first and a second shearing tool arrangement 12, 14 according to an embodiment of the shearing unit according to the invention. The housing 10 has a shearing chamber 16, in which the two shearing tool arrangements 12, 14 are arranged in an assembled state of the shearing unit (not shown in FIG. 1). The housing 10 further has an inlet 18 for loading the shearing chamber 16 with a mixture, which is to be sheared, containing starch and gluten, as well as an outlet 20 for gluten recovered from the mixture.

To convey the mixture through the shearing unit, the shearing unit housing 10 can be connected to a pump mechanism (not shown) on the inlet side, such as, for example, a hopper pump.

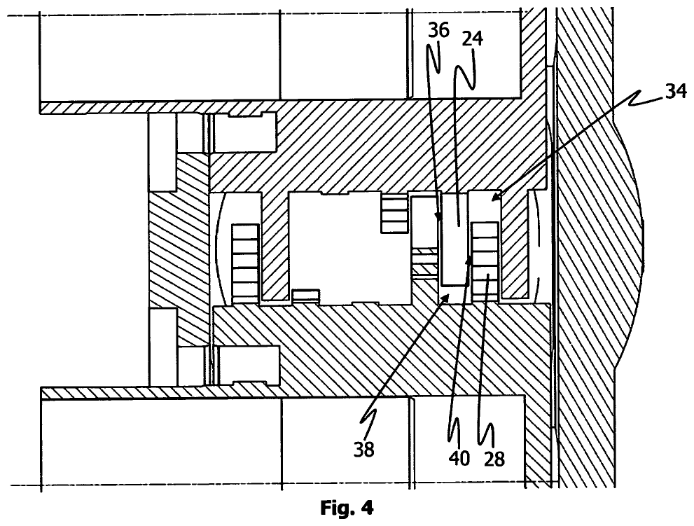

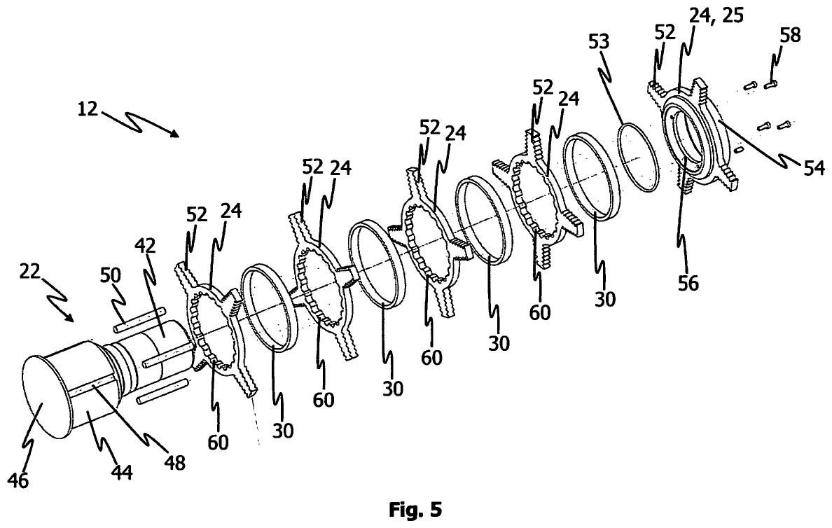

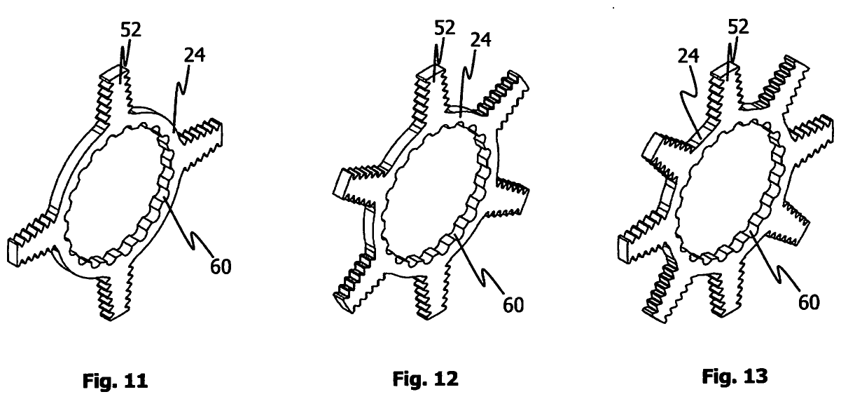

The first shearing tool arrangement 12 shown in FIG. 1 comprises a plurality of disk-shaped first shearing tools 24, which are arranged on a sleeve 22, while the second shearing tool arrangement 14 comprises a plurality of disk-shaped second shearing tools 28, which re arranged on a further sleeve 26. In the embodiment of the shearing unit according to the invention shown in FIG. 1, the first and second shearing tools 24, 28 are in each case formed separately from the corresponding sleeves 22, 26 and are assembled on the latter. Spacer rings 30, which axially space apart adjacent shearing tools 24, 28 from one another in the direction of a longitudinal axis of the respective shearing tool arrangement 12, 14, are arranged between adjacent first shearing tools 24 as well as between adjacent second shearing tools 28. The exact attachment of the shearing tools on the sleeve is described in more detail with regard to FIGS. 5 to 10, while the geometric formation of the shearing tools is discussed in detail in connection with FIGS. 11 to 13.

The first and second shearing tool arrangements 12, 14 can in each case be connected to a drive shaft (not shown) in a rotationally fixed manner, wherein the shaft of the first shearing tool arrangement 12 extends parallel to the shaft of the second shearing tool arrangement 14, and the two shafts are radially spaced apart from one another with regard to their axes of rotation, which is suggested by the lines L1, L2 in FIG. 1.

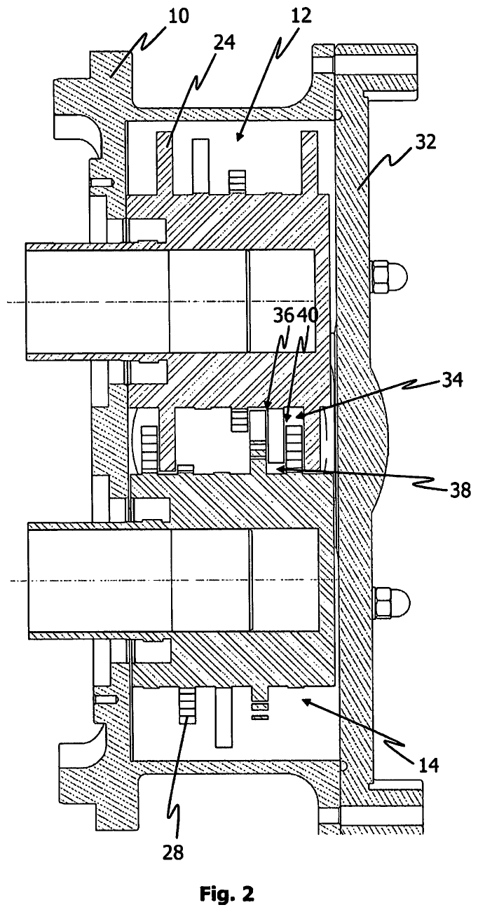

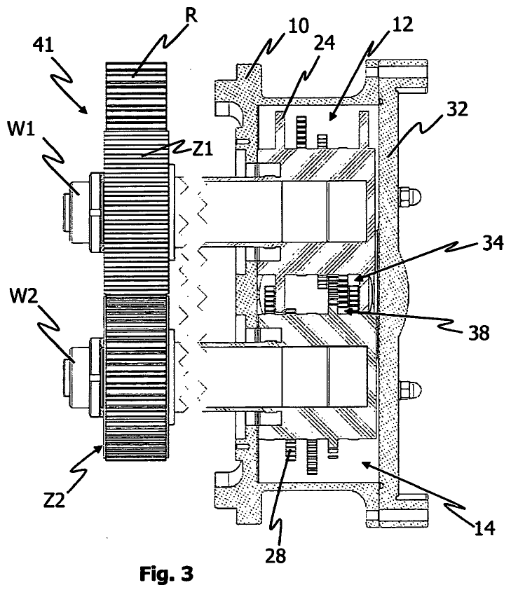

FIGS. 2 and 3 in each case illustrate a sectional illustration of the shearing chamber 16, which is tightly closed by means of a cover 32, of the shearing unit according to the invention, in which the first and the second shearing tool arrangements 12, 14 are arranged.

In contrast to the embodiment shown in FIG. 1, the first and second shearing tools 24, 28 of the embodiment according to FIGS. 2 and 3 are in each case formed in one piece with the corresponding sleeve 22, 26. The descriptions below with regard to FIGS. 2 and 3, however, apply for shearing tools, which are formed in one piece with the corresponding sleeve, as well as for shearing tools, which are formed separately from the corresponding sleeve.

By the arrangement of the shearing tool arrangements 12, 14 on the two shafts (not shown), the plurality of first shearing tools 24 is offset axially relative to the plurality of second shearing tools 28 in such a way that one portion of one of the plurality of second shearing tools 28 engages with an interspace 34. A gap 36 is in each case formed in the axial direction between the at least one engaging portion and the two adjacent first shearing tools 24 forming the interspace 34. In the shown embodiment, this gap 36 has an axial width of at least 0.3 mm, preferably of at least 0.5 mm.

It can further be seen from FIGS. 2 and 3 that a portion of one of the plurality of first shearing tools 24 also engages with a further interspace 38, wherein a further gap 40 is in each case formed in the axial direction between the at least one engaging portion of one of the plurality of first shearing tools 24 and the two adjacent second shearing tools 28 forming the further interspace 38. In the illustrated embodiment, this further gap 40 also has an axial width of at least 0.3 mm, preferably of at least 0.5 mm.

In the enlarged illustration shown in FIG. 4, the above-described interspaces 34, 38 and gaps 36, 40 can be recognized more easily, which shows a section of the view from FIGS. 2 and 3.

For the sake of clarity, only one interspace 34, one gap 36, one further interspace 38, and one further gap 40 are provided with reference numerals in FIGS. 2 and 4. It can be seen in the Figures, however, that additional interspaces are defined by means of adjacent first shearing tools 24 as well as by means of adjacent second shearing tools 28, with which a portion of the plurality of the other shearing tools engages in each case. The exact number of formed interspaces, of portions engaging therewith, and of gaps between first and second shearing tools defined thereby, can be selected virtually arbitrarily, depending on the formation of the shearing tool arrangements 12, 14.

During operation of the shearing unit according to the invention, the shearing tool arrangements 12, 14 are set into rotation by means of the shafts W1, W2, which are fixedly connected to the sleeves 22, 26. On an end facing away from the shearing tool arrangements 12, 14, the shafts W1, W2 are, for this purpose, in each case coupled to a drive mechanism (not shown, but typically an electric motor) via a belt drive 41. More precisely, the shafts W1, W2 are in each case coupled to a belt R of the belt drive 41 via gearwheels Z1, Z2, which are connected to the shafts W1, W2 in a rotationally fixed manner, as can be seen from FIG. 3. The shafts W1, W2 can be driven via the belt R, preferably at different speeds and/or directions of rotation. For this purpose, the belt R, coming from the drive mechanism in the shown illustration, runs along the rear side of the gearwheel Z1, extends between the gearwheels Z1, Z2 to the front side of the gearwheels, surrounds the gearwheel Z2 almost completely, and finally extends from the rear side of the second gearwheel Z2 to the drive mechanism (which is arranged above the gearwheels in the case of the exemplary embodiment according to FIG. 3), which is not shown.

Due to the rotation of the shearing tool arrangements 12, 14, portions of different first and second shearing tools 24, 28 temporarily engage with respectively assigned interspaces 34, 38 during the operation, whereby the mixture containing starch and gluten is conveyed through the gaps 36, 40, which form, and is stressed in a shearing manner. Due to the shear stresses, the mixture is broken up, whereby soluble components and, in particular starch is washed out of the mixture by means of water or another medium, which is additionally introduced into the shearing chamber 16. This increases the protein content and thus the quality of the gluten recovered by means of the processing.

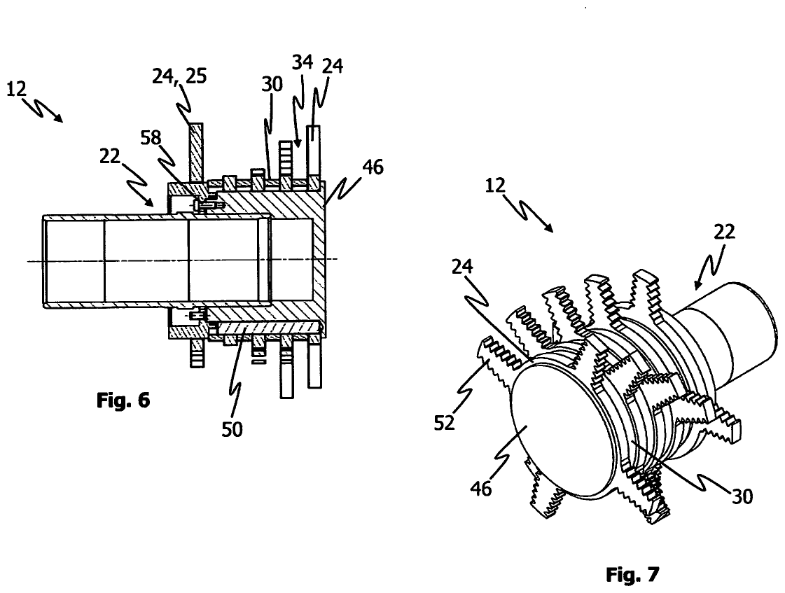

FIGS. 5 to 7 show an exemplary first shearing tool arrangement 12 of the shearing unit according to the invention in a perspective exploded drawing (FIG. 5), of a sectional illustration (FIG. 6), and in a perspective view (FIG. 7).

As can be seen from FIGS. 5 and 6, the sleeve 22 of the first shearing tool arrangement 12 has a portion 42 of a first diameter, which transitions into a portion 44 of a second diameter, wherein the first diameter is smaller than the second diameter. The portion 42 with the first diameter is at least partially hollow and has a receiving opening for receiving an end region of a drive shaft (not shown), to which the sleeve 22 can be connected in a rotationally fixed manner. The portion 44 with the second diameter adjoins the portion 42 with the first diameter at an end thereof opposite the receiving opening. At an end of the portion 44 with the second diameter opposite to the receiving opening, the sleeve 22 is defined by a cover plate 46, which has a larger diameter than the portion 44 with the second diameter. The cover plate 46 and the two portions 42, 44 of the sleeve 22 are formed in one piece in the shown example. In particular the cover plate 46, however, can also be formed as separate component and can be fixedly connected to the portion 44.

Four elongated grooves 48, which extend axially across the entire length of the portion 44, are furthermore formed in the outer circumferential surface of the portion 44 of the sleeve 22. In further embodiments of the invention, an arbitrary plurality of such grooves can be present in the outer circumferential surface of the portion 44 of the sleeve 22. The grooves 48 are in each case formed to receive a separate pin 50 in sections, as will be described in more detail below.

As can be seen from the illustrations of FIGS. 5 to 7, five disk-shaped shearing tools 24 are arranged coaxially to the sleeve 22 and are pushed onto the sleeve 22 in sequence for assembly purposes. More specifically, the shearing tools 24 are pushed onto the portion 44 of the second diameter of the sleeve 22 for assembly purposes. The shearing tools 24 are thereby axially defined by the cover plate 46 in that the shearing tool 24 adjacent to the cover plate 46 comes to bear on the former, wherein the outer diameter of the cover plate is larger than the diameter of the inner circumference of the adjacent shearing tool 24.

A spacer ring 30, which is also pushed onto the portion 44 of the sleeve 22 for assembly purposes, and thus in each case spaces apart adjacent shearing tools 24 from one another, is in each case arranged between two adjacent shearing tools 24. The diameter of the inner circumference of the shearing tools 24 and of the spacer rings 30 is slightly larger than the second diameter of the portion 44, so that a pushing and pulling of the shearing tools 24 and of the spacer rings 30 onto the or off the portion 44 with the second diameter, respectively, is possible in a simple way.

In the shown exemplary embodiment, the disk-shaped shearing tools 24 are embodied in a star-shaped manner and each have four star points 52. A serration is formed at each of the star points 52 of the shearing tools 24. It goes without saying that a different geometric formation of the disk-shaped shearing tools with and/or without serration is also possible.

On a first side facing the cover plate 46 of the sleeve 22, the shearing tool 25 of the five shearing tools 24, which locks the first shearing tool arrangement 12 and which is spaced apart farthest from the cover plate 46 in the assembled state, is formed complementary in sections to the transition region of the sleeve 22 between the portion 42 with the first diameter and the portion 44 with the second diameter, and engages therewith in the assembled state. On a second side facing away from the cover plate 46 of the sleeve 22, the locking shearing tool 25 also comprises a ring flange 54.

A sealing ring 53 is further provided, which, in the assembled state, is arranged radially between a portion of the locking shearing tool 25 and the transition region of the sleeve 22.

The locking shearing tool 25 further has bores 56, which extend from its second side to its first side. For assembling the first shearing tool arrangement 12, screws 58 are introduced from the second side of the locking shearing tool 25 into the bores 56 and are screwed into the transition region of the sleeve 22. The screw heads of the screws 58 thereby come to bear with a surface on the second side of the locking shearing tool 25. The locking shearing tool 25 and the further shearing tools 24 and the spacer rings 30 are fixed horizontally on the sleeve 22 by means of this screw-connection. In addition, at least the locking shearing tool 25 is connected to the sleeve 22 in a rotationally fixed manner by means of the screw connection.

To ensure a rotationally fixed connection of the further shearing tools 24 with the sleeve 22, the further shearing tools 24 have, along their inner circumference, a plurality of consecutive recesses 60, which are formed to receive the pins 50 in sections. It goes without saying that the number of the recesses 60 formed on the inner circumferential surfaces of the further shearing tools 24 can be selected almost arbitrarily in alternative embodiments of the invention, whereby the number of the recesses 60 in each of the further shearing tools 24 has to correspond to at least the number of the pins 50. However, a provision of a number of recesses, which is as large as possible, simplifies the assembly of the shearing tools 24 on the sleeve 22.

When pushing the shearing tools 24 onto the sleeve 22, the pins 50 engage with the grooves 48 with a region of their circumferential surface and with the recesses 60 with a different region of their circumferential surface. In an assembled state of the first shearing tool arrangement 12, the pins 50 are thus arranged between the shearing tools 24 and the sleeve 22, whereby a rotationally fixed connection is established between the shearing tools 24 and the sleeve 22.

The assembled first shearing tool arrangement 12 is arranged in the shearing unit according to the invention in such a way that the surface of the locking shearing tool 25, which engages with the screw heads, is located outside of the shearing chamber 16. In the assembled state of the first shearing tool arrangement 12, the screw heads of the screws 58 are thus also arranged outside of the shearing chamber 16, so that they can also not reach into the mixture, which is to be processed, in the event of a loosening.

The above-described embodiment of the first shearing tool arrangement 12 thus provides for a rotationally fixed connection, which is screwless inside the shearing chamber 16, of the shearing tools 24 to the sleeve 22. Due to the fact that, in its interior, the sleeve 22 is also fixedly connected to the drive shaft (not shown), a screwless connection of the first shearing tool arrangement 12 or of the shearing tools 24, respectively, to the drive shaft is also ensured inside the shearing chamber 16. This is advantageous for the use of the shearing unit according to the invention in the food industry.

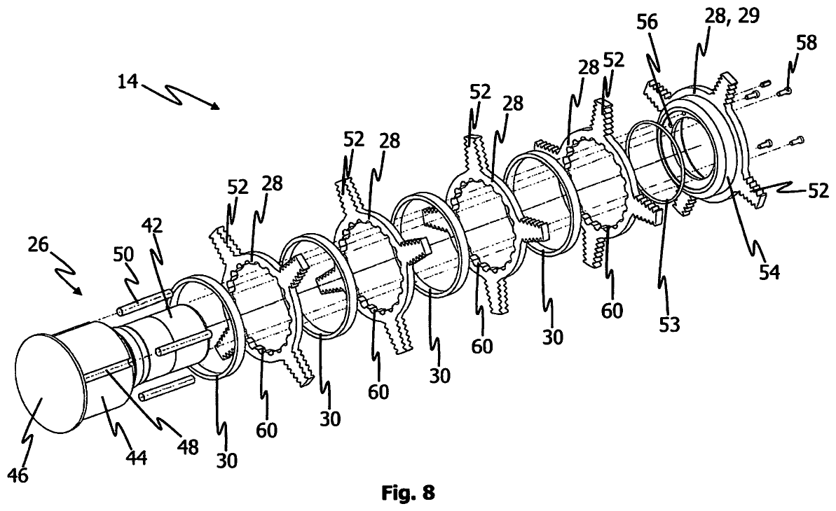

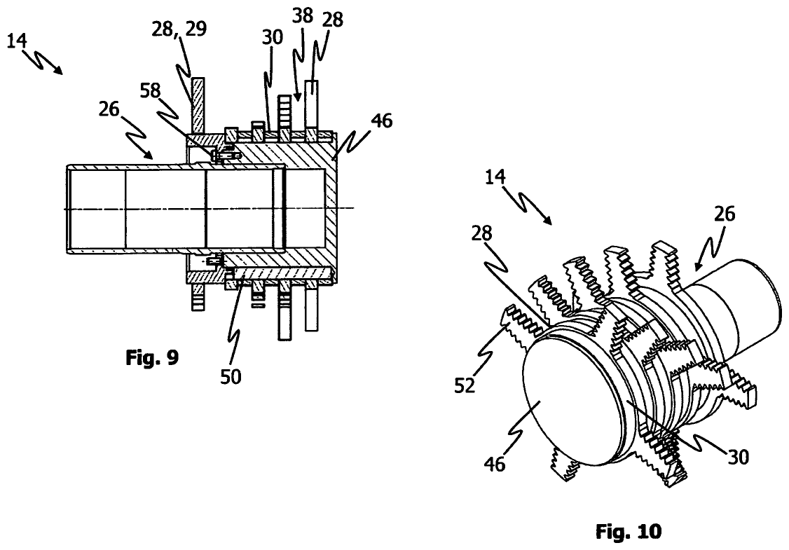

FIGS. 8 to 10 show an exemplary second shearing tool arrangement 14 of the shearing unit according to the invention in a perspective exploded drawing (FIG. 8), a sectional illustration (FIG. 9), and in a perspective view (FIG. 10). The exemplary second shearing tool arrangement 14 of the FIGS. 8 to 10 essentially corresponds to the first shearing tool arrangement 12 shown in FIGS. 5 to 7. Only the differences between the shearing tool arrangements of FIGS. 8 to 10 and of FIGS. 5 to 7 will thus be discussed below.

In contrast to the above-described first shearing tool arrangement 12, the second shearing tool arrangement 14 of FIGS. 8 to 10 comprises a further spacer ring 30, which is arranged between the cover plate 46 of the further sleeve 26 and the shearing tool 28 adjacent thereto, and which is supported relative to the cover plate 46 and the adjacent shearing tool 28. In contrast, no additional spacer ring is arranged between the locking shearing tool 29 and a shearing tool 28 adjacent thereto. The locking shearing tool 29 and the shearing tool 28 adjacent thereto are only spaced apart from one another by means of a ring flange 55 of the locking shearing tool in the second shearing tool arrangement 14. In the exemplary embodiment shown in FIGS. 8 to 10, this ring flange 55 extends from the locking shearing tool 29 in the direction of the adjacent shearing tool 28.

Due to the different formation and/or arrangement of the first and second shearing tool arrangements 12, 14 or the first and second shearing tools 24, 28, respectively, on the corresponding sleeves 22, 26, a provided, axial offset of the first and second shearing tools 24, 28 in an assembled state of the shearing unit according to the invention can be attained. This axial offset ensures that portions of the first and second shearing tools 24, 28, more precisely of the star points 52, temporarily engage with corresponding interspaces 34, 38, which are formed by the respective other shearing tools 24, 28, during an operation of the shearing unit according to the invention.

By means of a selection of the axial width of the first and second shearing tools 24, 28 as well as of the spacer rings 30, the axial width of the gaps 36, 40 can additionally be determined between the respective engaging portion and the corresponding adjacent shearing tools forming the interspace.

FIGS. 11 to 13 show different exemplary embodiments of disk-shaped shearing tools 24, 28 of the shearing unit according to the invention. All shearing tools 24, 28 of the shown embodiments have a star-shaped shape, whereby serrations are in each case formed on the star points 52. While FIG. 11 shows a disk- and star-shaped shearing tool 24, 28 comprising four star points 52, FIG. 12 illustrates a disk- and star-shaped shearing tool 24, 28 comprising six star points 52, and FIG. 13 illustrates a disk- and star-shaped shearing tool 24, 28 comprising eight star points 52. In further embodiments, which are not shown, the disk-shaped shearing tools of the shearing unit according to the invention can be of any, non-star-shaped geometric shape with or without serration. For example, the shearing tools can have a wave-shaped outer circumference with or without serration in sections. In addition, it is possible that shearing tools of different shape can also be provided inside the shearing tool arrangement or between the two shearing tool arrangements of the shearing unit according to the invention.

It goes without saying that the above-described exemplary embodiments of the invention are not final and are not to limit the subject matter of the invention. It is, in particular apparent for the person of skill in the art that he can combine the features of the different embodiments with one another and/or can omit different features of the embodiments, without thereby deviating from the subject matter of the invention.

1. A shearing unit for recovering gluten from a mixture containing starch and gluten, comprising;
a housing, in which a shearing chamber including an inlet and an outlet is formed,
a first shaft, which is rotatably mounted in the housing and which has a plurality of disk-shaped first shearing tools, which are attached to the first shaft, in a rotationally fixed manner, wherein two adjacent shearing tools of the plurality of first shearing tools are in each case axially spaced apart from one another, so that they form an interspace,
a second shaft, which is rotatably mounted in the housing and which is arranged parallel to the first shaft and which has a plurality of disk-shaped second shearing tools, which are attached to the second shaft in a rotationally fixed manner, wherein two adjacent shearing tools of the plurality of second shearing tools are in each case axially spaced apart from one another, so that they form a further interspace,
wherein the first and second shearing tools are arranged in the shearing chamber,
wherein the first and the second shaft are radially spaced apart from one another and the plurality of first shearing tools is offset axially relative to the plurality of second shearing tools in such a way that at least one portion of one of the plurality of second shearing tools engages with an interspace, and
wherein a gap of a width of at least 0.3 mm, preferably at least 0.5 mm, is in each case formed in the axial direction between the at least one engaging portion and the two adjacent first shearing tools forming the interspace.

2. The shearing unit according to claim 1, in which at least one portion of one of the plurality of first shearing tools engages with the further interspace, and
wherein a further gap of a width of at least 0.3 mm, preferably at least 0.5 mm, is in each case formed in the axial direction between the at least one engaging portion of one of the plurality of first shearing tools and the two adjacent second shearing tools forming the further interspace.

3. The shearing unit according to claim 1, in which the gap and/or the further gap has an axial width of at least 1 mm.

4. The shearing unit according to claim 1, in which the first shearing tools and/or the second shearing tools are star-shaped.

5. The shearing unit according to claim 4, in which a serration is formed on an outer circumferential surface of at least one star point of the first shearing tool and/or of the second shearing tool at least in sections.

6. The shearing unit according to claim 1, in which the plurality of first shearing tools and/or the plurality of second shearing tools is arranged on a sleeve in a rotationally fixed manner, and
wherein the sleeve is connected to the corresponding first and/or second shaft in a rotationally fixed manner.

7. The shearing unit according to claim 1, in which the plurality of first shearing tools and/or the plurality of second shearing tools is fastened to the corresponding shaft inside the shearing chamber in a screwless manner.

8. The shearing unit according to claim 1, which further comprises a drive mechanism, which is connected to the first shaft and the second shaft via a belt drive,
wherein the drive mechanism is designed to rotate the first shaft at a first speed and to rotate the second shaft at a second speed by means of the belt drive.

9. The shearing unit according to claim 8, in which the first speed differs from the second speed and/or in which the direction of rotation of the first shaft differs from the direction of rotation of the second shaft.

10. The shearing unit according to claim 1, which further comprises a secondary substance inflow, which is set up to supply a medium to the shearing chamber.

11. The shearing unit according to claim 10, in which the secondary substance inflow is a water lance, which is set up to supply water to the shearing chamber, wherein a supply opening of the water lance is preferably arranged in the region of the inlet of the shearing chamber.

12. A system comprising a shearing unit having:
the shearing unit according to claim 1, in which the plurality of first shearing tools an/or the plurality of second shearing tools is fastened to the corresponding shaft inside the shearing chamber in a screwless manner,
and a pump mechanism connected thereto, preferably a hopper pump, which is set up to convey a mixture, which is to be sheared, through the shearing chamber of the shearing unit.

13. A method for recovering gluten from a mixture containing starch and gluten, comprising the steps:
supplying a mixture into a shearing chamber of a shearing unit, in particular of a shearing unit according to claim 1,
rotationally driving a first shaft, which has a plurality of disk-shaped first shearing tools, which are attached to the first shaft in a rotationally fixed manner, wherein two adjacent shearing tools of the plurality of first shearing tools are in each case axially spaced apart from one another, so that they form an interspace,
rotationally driving a second shaft, which is arranged parallel to the first shaft and which has a plurality of disk-shaped second shearing tools, which are attached to the second shaft in a rotationally fixed manner, wherein two adjacent shearing tools of the plurality of second shearing tools are in each case axially spaced apart from one another, so that they form a further interspace,
wherein the first and second shearing tools are arranged in the shearing chamber,
repeatedly allowing at least one portion of one of the plurality of second shearing tools to engage with the interspaced by rotationally driving the first and the second shaft, wherein a gap of a width of at least 0.3 mm, preferably at least 0.5 mm, is each case formed in the axial direction between the at least one portion and the two adjacent first shearing tools forming the interspace.

14. The method according to claim 13, comprising the further steps:
supplying a medium into the shearing chamber, and
rinsing the starch, which was dissolved out, out of the mixture by means of the supplied medium.

15. The shearing unit according to claim 1, in which the gap and/or the further gap has an axial width of at least 2 mm.

16. The shearing unit according to claim 2, in which the first shearing tools and/or the second shearing tools are star-shaped.

17. The shearing unit according to claim 2, in which the plurality of first shearing tools and/or the plurality of second shearing tools is arranged on a sleeve in a rotationally fixed manner, and
wherein the sleeve is connected to the corresponding first and/or second shaft in a rotationally fixed manner.

18. The shearing unit according to claim 2, in which the plurality of first shearing tools and/or the plurality of second shearing tools is fastened to the corresponding shaft inside the shearing chamber in a screwless manner.

19. The shearing unit according to claim 2, which further comprises a drive mechanism, which is connected to the first shaft and the second shaft via a belt drive,
wherein the drive mechanism is designed to rotate the first shaft at a first speed and to rotate the second shaft at a second speed by means of the belt drive.

20. The shearing unit according to claim 2, which further comprises a secondary substance inflow, which is set up to supply a medium to the shearing chamber.
